(19) United States
(12) Patent Application Publication
(10) Pub. No.: US 2012/0112879 A1
(43) Pub. Date: May 10, 2012

(54) Apparatus and method for improved vehicle safety

(76) Inventors: Caroline M. Ekchian, Belmont, MA (US); Jack A. Ekchian, Belmont, MA (US)

(21) Appl. No.: 13/373,253

(22) Filed: Nov. 9, 2011

Related U.S. Application Data
(60) Provisional application No. 61/456,615, filed on Nov. 9, 2010.

(51) Int. Cl. G08B 29/00

(52) U.S. Cl. 340/5.53

(57) ABSTRACT

A vehicle access system is disclosed for preventing the operation of vehicles by operators who are impaired due to various reasons including alcohol consumption, drug use and fatigue. The system identifies the vehicle operator and implements automated tests or tests with manual intervention to determine the ability of vehicle operators to properly control the vehicle prior to and during the operation of the vehicle.

### CROSS-REFERENCE TO RELATED APPLICATIONS

This application claims priority of U.S. Provisional Patent Application No. 61/456,615, entitled “Apparatus and method for improved vehicle safety”, filed Nov. 9, 2010, which is hereby incorporated by reference in its entirety.

### FIELD OF INVENTION

This invention relates to the field of vehicle operation and, more particularly, to a vehicle access control system (VACS) for the detection of impaired operators and mitigation or prevention of unsafe vehicle operation. Unsafe operation may arise due to a variety of reasons including, for example, the vehicle operator being under the influence of drugs or alcohol, medication, or suffering from a lack of sleep or a medical condition. Other reasons which may result in unsafe operation include the operator's carelessness or inexperience or the ignoring of laws and regulations.

### BACKGROUND

Cars and trucks are critical to our economy and an integral part of our daily lives. Unfortunately, they are also the cause of much carnage and tragedy on our roads and highways. Over the past decade, approximately 400,000 people have lost their lives in motor vehicle crashes in the US. Shockingly, this number is approximately equal to the total number of US deaths during WWII. In addition, over 20,000,000 people were injured on US highways (DOT #S811172) during the same period. The economic toll is also shocking. It is noteworthy that over 95% of motor vehicle accidents in the USA and Europe involve some degree of undesirable driver behavior (www.smartmotorist.com).

In recent years, there has also been an increasing effort to address an important aspect of deleterious driver behavior, i.e. drunk driving. However, despite increasingly stringent laws and penalties and the use of devices such as breathalyzer ignition interlocks and ankle bracelets with alcohol detection, driving under the influence of alcohol remains a serious problem. In the last decade, there have been in excess of 160,000 alcohol related fatalities in the US alone (alcoholalert.com). Approximately 1.5 million drivers were arrested in the US for driving under the influence of alcohol or narcotics in 2006. This is approximately one for every 139 licensed drivers (www.madd.org). Countless other drunk drivers have gone unnoticed. Alcohol-related accidents in the US cost approximately $114.3 billion dollars in 2000 including monetary and quality of life losses. It is estimated that in 2002, there were 159 million alcohol impaired driving trips; over 18 million trips were by 18-20 year olds.

Unfortunately, behind these statistics are many personal and family tragedies. These statistics also demonstrate our inability to effectively deal with this problem. Typically, a very small fraction of drunk drivers on the road at any one time are apprehended. Even when police are able to intercept a drunk driver, it is frequently after many miles have been traveled with the impaired driver at the wheel. The average distance driven by a drunk driver before being stopped by police is 3.4 miles (www.sciencedirect.com). As a result, drunk driving exposes everyone who travels our roads to an elevated risk of injury or death. The arrest of drunk drivers by police, while necessary, appears to be insufficient.

Also, all persons do not react to alcohol equally in all circumstances. Limiting drivers to a certain blood alcohol content with a breathalyzer or other device may work well for some individuals under certain conditions. However, a “one size fits all” blood alcohol level ignores differences between individuals and circumstances. Nevertheless, there has been increasing reliance on alcohol interlocks to ensure that convicted drunk drivers do not drive drunk again. One example of such an effort is New York state's Leandra's Law that mandates that anyone convicted of drunk driving be required to install an ignition interlock breathalyzer device on his or her car. The system disables the car's ignition if the driver fails an automated in-vehicle breathalyzer test.

Unfortunately, such devices can be circumvented, for example, by having a sober person, other than the driver, take the breathalyzer test. Alternatively, devices such as air pumps may be used to “fool” the breathalyzer. To reduce attempts to circumvent a breathalyzer interlock device, some systems are designed to retest the driver at frequent intervals. This method is sometimes called the Random Rolling Test. U.S. Pat. No. 7,287,617, the contents of which are incorporated herein by reference in their entirety, describes an ignition interlock system with retest capability, U.S. Pat. No. 6,726,636, the contents of which are incorporated herein by reference in their entirety, describes an ignition interlock and a voice recognition system. Such precautions, however, may be ineffective if a sober vehicle passenger is available to take the test or if an effectively configured pump is used to blow into the breathalyzer. Repeatedly taking a breathalyzer test while driving may also be distracting for a driver and may actually cause an accident. Breathalyzers are also prone to error and represent only an indirect measure of one's reflexes, acuity or alertness and hence the ability to drive safely. As a result, many drivers in an impaired condition discount breathalyzer results because they “feel fine.” Also, under certain circumstances, even legal levels of blood alcohol may be too much because a driver's reflexes may already be diminished due to other reasons such as, for example, lack of sleep or use of various medications. Passing a blood alcohol level test may, therefore, create a false sense of security. Also, breathalyzer interlocks also may stigmatize innocent famly members of a convicted drunk driver who may need to drive a car outfitted with such a device. They are also inconvenient for others, such as mechanics or parking attendants, who must operate the vehicle.

Court-ordered ankle bracelets are also utilized to monitor alcohol consumption by certain individuals. Methods and apparatus for monitoring blood alcohol level using an ankle bracelet are described in U.S. Pat. No. 7,641,611, the contents of which are incorporated herein by reference in their entirety. These devices not only suffer from many of the limitations of a breathalyzer interlock system, they are also passive and not effective in keeping inebriated individuals from operating motor vehicles.

Devices such as breathalyzers and ankle bracelets can typically only be implemented after a person has been arrested and convicted of a criminal offense. Consequently, the breathalyzer interlocks and ankle bracelets cannot prevent countless people who are intoxicated or otherwise impaired from operating vehicles.

An alternative to breathalyzers is described in U.S. Pat. No. 4,723,625, the contents of which are incorporated herein by reference in their entirety. A handheld ignition interlock device is used to gauge the reflexes of a person before allowing a vehicle to be started. It measures the time taken to press various buttons after being prompted to do so. However, such a device may easily be circumvented by a nondriver occupant of the vehicle. Even a young child could be taught to take the test instead of a potentially impaired driver.

Mistakes made by inexperienced drivers, such as speeding and failing to obey traffic regulations, lead to many accidents with or without the compounding effect of alcohol or drugs. As a result, many insurance companies charge substantially increased premiums for auto insurance when young drivers have access to a vehicle.

Fatigued drivers can also increase the risk of accidents. A recent analysis by the National Highway Traffic Administration has concluded that almost one in six of deadly crashes, one in eight of crashes requiring occupant hospitalization, and one in 14 crashes in which a vehicle needed to be towed involved a driver who was sleep deprived (www.aaafoundation.org). Current technologies, such as breathalyzers, are totally ineffective in detecting and stopping drivers who are impaired due to any reason other than alcohol consumption. This is especially dangerous because many drivers, such as drowsy drivers, frequently do not realize that they are impaired.

Unfortunately, there have also recently been increasing reports of individuals attempting to operate other types of vehicles such as commercial or civil aircraft and various watercraft while impaired with horrific results. Typically there are no devices on such vehicles that can detect an impaired operator.

Many drivers who drive while impaired either do not care or are incapable of correctly gauging their abilities prior to getting behind the wheel of a car. The same is true of those who operate other types of vehicles under impaired conditions.

### SUMMARY OF THE INVENTION

It is an object of this invention to curtail or prevent the operation of a vehicle by an individual who is impaired for any reason and cannot meet certain criteria of alertness, acuity or reflex response (AARR). Such deficit in AARR may be due to various reasons such as, for example, intoxication, effects of drugs or medication or the lack of sleep. Curtailing the operation of the vehicle by such an individual may include restricting the operation to, for example, certain times of the day, certain geographical locations, and certain roads or speeds.

It is a further object of this invention to use an automated vehicle access control system (VACS) to identify a person attempting to start a vehicle and control his or her access to that vehicle. Preferably the identity of the operator will also be confirmed periodically while the vehicle is in motion. If the vehicle is a car, the person sitting in the driver's seat will be identified. Identification techniques such as facial recognition, voice recognition or other biometric analysis may be used. Other biometric data, such as, for example, fingerprints, palm prints, iris scans, hand geometry scans or ear lobe scans may also be used to identify the person sitting in the driver's seat. The biometric analysis apparatus will be positioned and configured to obtain vehicle operator data and exclude data from others in the vehicle. A database, for example, of voice or fingerprint information, facial recognition or other biometric data may be obtained under controlled conditions, at, for example, a state motor vehicle department or police station. Such data may be stored onboard the vehicle or at a remote location and used for comparison with data obtained by the VACS prior to startup and/or during operation. The contents of U.S. Pat. Nos. 6,326,644; 6,952,490; and 7,525,537 and US patent application 2010/0189315, incorporated herein by reference in their entirety, describe fingerprint recognizing technology.

The VACS may also be used to detect and interpret transmissions from, for example, a transmitter or ID tag attached to a person, when such person is in the driver's seat. Such transmitters may be incorporated in, for example, an ankle bracelet worn by an individual voluntarily or by court order. In a car, the receiver may be configured to receive such information only when the transmitter is in the driver's wheel well area.

Multiple strategically located microphones in the vehicle may be used so that the words spoken by the person sitting in the driver's seat of a car can be differentiated from those spoken by others sitting elsewhere. Various operator identification techniques may be used to confirm operator identity.

If the operator cannot be identified, the operation of the vehicle may be curtailed or prevented by the VACS. Alternatively, the VACS may establish a link with a predetermined individual or facility so that the identification process may be performed remotely with the aid of a trained person. The would-be operator may be offered this option and charged a fee for such a service.

It is a further object of this invention to use an automated VACS to gauge the AARR of an individual operating or wishing to operate a vehicle. Individuals who may be tested include, for example, drivers with previous DUI convictions, student drivers, and people with an extensive number of previous accidents. Preferably, the identity of the individual providing responses during a test is confirmed during the test by using, for example, devices such as touch sensitive fingerprint scanners. Such a scanner may be configured to scan fingerprints when it is touched by the operator during the performance of the test, while simultaneously determining when the scanner was touched. The test may comprise the measurement of the time interval between the successful start and completion of a test or when the test subject is instructed to touch various touch sensitive surfaces or devices. If the test subject fails to meet previously established thresholds, the system may curtail or abort the operation of the vehicle. Alternatively, the system may establish a communication link with a predetermined individual or facility so that tests may be given by a human test giver. The would-be operator may be offered the option and charged for such a service.

It is a further object of this invention to use voice analysis of the vehicle operator to determine if the vehicle operator is impaired, for example, due to alcohol consumption. Slurred speech has long been recognized as an indicator of intoxication and frequently used by law enforcement. It is also recognized that alcohol consumption has an effect on certain phonetic parameters of speech. For example, it is recognized that sentences spoken by an intoxicated individual typically have longer durations than the same sentences spoken when the individual is sober. It is also recognized that there is a degree of pitch level variability in the speech of an intoxicated individual. The VACS may automatically ask the test subject to speak certain sentences or a series of words as a part of the test. Voice samples may also be obtained when the operator is engaged in normal conversation with others in the vehicle or while using, for example, a cell phone. Such samples may be analyzed to determine the number of errors or changes in certain parameters such as pitch variability, vowel lengthening, and consonant deletion. Results during tests will be compared to baseline speech parameters in a database. Baseline parameters may include individualized representative parameters obtained from the analysis of voice records of the operator or a representative group which are obtained under controlled conditions. Preferably, if the automated system detects differences in these parameters or determining that the driver is driving erratically, the operation of the vehicle will be aborted. Alternatively, the VACS may be used to open a communication line, preferably at the test subject's option and expense, with a technician who may attempt to confirm the results of the test. During this testing, the technician may compare the test subject's speech with prerecorded speech to determine if the speaker is intoxicated or otherwise impaired. The technician may then instruct the subject to take other tests or abort the operation of the vehicle. A video link may also be used to allow the technician to observe the operator.

Baseline voice data from individuals, when unimpaired, may be captured and stored in the VACS data storage or elsewhere so that it may be accessed. Such baselines may be augmented by analyzing recorded conversations in a vehicle or on a cell phone or during answers to queries by the system. Such comparisons may be made in wholly automated fashion or by the intervention of a technician.

Automatic voice analysis by the VACS or with the intervention of a remotely located technician may also be used to determine the fatigue level of the operator. U.S. Pat. Nos. 6,236,968 and 6,876,964, incorporated herein by reference in their entirety, describe apparatus for detecting fatigue or other impairment using voice analysis.

The AARR level of the operator may also be determined by instructing the operator to take certain actions or to respond verbally to certain commands or instructions and then measuring the time until the proper response is obtained.

For example, the vehicle operator may be instructed by, for example, visual, acoustic or tactile cues or commands to perform certain tasks. The test subject may be instructed to perform such tasks by, for example, synthesized, prerecorded commands or live voice commands by a remotely located person or technician. Acoustic cues such as chimes or buzzers may also be used to initiate a test. The system will then detect when and if the instructions are followed properly and the time taken to complete the task. The time may then be recorded and compared to the predetermined thresholds.

Visual instructions or cues may include, for example, text displayed on a screen such as an LCD or plasma display. Alternatively, visual cues or instructions may be given by the system by, for example, illuminating certain lights or specially located LED's that can conveniently be observed only by the vehicle operator. These instructions may be given in such a manner that only the vehicle operator can readily receive them. The verbal queries or instructions may at first be in low volume. Volume may be increased until the operator responds as required. The volume at which the operator first responds may also be used as a measure of the operator's AARR level.

Test subjects may also be asked to perform tasks that are typically performed by a vehicle operator in the normal course of vehicle use. For example, the driver of a car may be asked to press the horn, turn on the radio, select a certain station on the radio, turn on the high beams, turn on the emergency flashers or depress the brake pedal after a cue is given. Sensors will then be used to measure the interval between the time when the cue is given to begin a task and when the task is attempted and/or properly performed. Such sensors may detect the motion of, for example, the brake pedal or the current draw of the high beam circuit or radio circuit in the car. The system may also momentarily disable certain functions of certain devices for the purposes of this test. For example if, during the test, the driver is instructed to press the horn when a cue is given, the VACS may temporarily disable the horn so that when the operator presses it, it only functions as a touch sensitive detection device and does not produce any sound as it does during normal use. The system may then return the horn to normal function after the test is completed.

Alternatively, the task may entail the use of a special purpose device such as, for example, a switch, button or other touch sensitive detector pad that may be pushed or tripped to close a circuit or generate a signal in a manner that may be detected by the system.

Alternatively or additionally, the VACS may require verbal responses from the test subject. Again the time interval until a proper response is received and/or attempted may be determined by the system. For example, the test subject may be asked to repeat a list of words in reverse order or to solve a simple math problem and speak the answer. Preferably, the verbal responses are evaluated automatically by, for example, using speech recognition. Alternatively, questions may be asked and answers evaluated with the intervention of a person at a remote location using a communication link. Speech recognition apparatus are described in U.S. Pat. Nos. 7,813,928 and 7,820,900, the contents of which are incorporated herein by reference in their entirety.

The system may also store a library of voice records of correct responses made by individuals who may be authorized or expected to operate the vehicle. Responses obtained from a given operator during testing may be compared to results obtained earlier. If, for example, it is determined that the response time is greater than a threshold amount, the test may be considered a failure.

It is a further object of this invention to maintain individualized and/or general population baseline data such as reaction time for a given set or class of tasks. Results obtained during tests in real time may then be compared to previously obtained baseline data for an individual. Such data may be retained within the vehicle or at a remote location to be accessed when necessary using a communication link. Stored data may also include baseline data about accepted norms of reaction time expected for various tests in general or for a representative group.

It is a further object of this invention to identify periods during the operation of a vehicle where the operator may safely be tested while operating the vehicle. Parameters that may be monitored are, for example, vehicle speed and the proximity of surrounding traffic or obstructions. The location and timing of the test may be selected and the speed of the vehicle during the test may be altered or limited by the VACS for the duration of the test to ensure safety. Drivers may also be permitted to request a delay of the test for a limited time period. The VACS may also select the time for performing the test so that the operator is minimally distracted from other critical tasks. U.S. Pat. No. 6,925,425, the contents of which are incorporated herein by reference in their entirety, describes a method for evaluating the sensory load on the vehicle operator. In certain cases when, for example, the vehicle is a car or truck, if no convenient and safe location for conducting the test can be found or if the operator requests it, the operator may be asked to leave the road to locate a convenient place for the test to be administered.

However, if the VACS determines that there may be imminent danger due to the impairment of the operator, the system may take partial or full control of the vehicle. U.S. Pat. No. 6,643,578, the contents of which are incorporated herein by reference in their entirety, describes a vehicle override system.

In the case of testing pilots before they are allowed to operate aircraft, it is preferred that rigorous testing occurs prior to takeoff. However, if testing during flight indicates that the pilot is impaired, for example, due to fatigue, the pilot may be instructed to take action that will mitigate the impairment. Such recommendations may include, for example, instructing that another pilot take over the operation of the aircraft, that the pilot take medication such as NoDoz, drink coffee, seek other relief or even land the plane as soon as possible.

Pilots may be tested prior to take-off on board the airplane, at a location at the airport or at a remote location prior to arriving at the airport. Specialized stations may be used to measure a pilot's AARR while simultaneously collecting sufficient biometric data to ensure the identity of the test taker. For example, AARR of a pilot may be measured by instructing him to touch or depress buttons or other touch sensitive devices that measure the length of time during which they are touched while collecting the fingerprint of the person touching one or more of these devices or buttons. In addition or in the alternative, the test subject pilot may be asked to respond verbally to system generated prompts or instructions. The responses may be interpreted and evaluated using voiceprint analysis and identification. Voiceprint identification may be accomplished by comparing the voiceprint of the test taker with previously recorded voiceprints of pilots. The system may also use voiceprint analysis to directly determine the pilot's level of fatigue or intoxication as well as determining his or her AARR by determining the accuracy and speed by which the pilot responds verbally. Test subjects may also be instructed to type on a keyboard or use a joystick.

It is a further object of this invention to monitor the AARR of the operator of a vehicle during the operation of the vehicle without notifying the operator. This may be performed in the background, for example, by using voice analysis or by monitoring how quickly and effectively the operator performs normal driving tasks such as braking when necessary or whether the operator stops at stop signs or yields to traffic as required.

It is a further object of this invention to limit the range of operating capabilities of a vehicle available to a particular vehicle operator. These limitations may be applied whenever a certain individual assumes control of a vehicle or when any vehicle operator's AARR is determined to be below certain thresholds. Alternatively, such limitations may also be applied regardless of any test results, for example, when it is determined that the operator is an inexperienced operator such as a driver with a learner's permit or one who has recently obtained a license. Such limitations may also be imposed on an individual who has operated the vehicle recklessly on one or more earlier occasions. Vehicles operating in such circumstances may be limited by enforcing a maximum vehicle speed or by restricting localities where the vehicle may be used and the times of the day when the vehicle may be operated by a given individual. For example, the operation of a car may be limited when being driven by a particular individual, for example, as a result of a court order. For example, such a driver may be allowed to travel back and forth from work only at certain times and days and only over certain roads and at certain maximum speeds. The driving of an inexperienced driver may be limited, for example, to daylight hours, to speeds below a threshold and to certain roads. The maximum speed of the vehicle may also be limited to a certain percentage of the prevalent speed limit. For example, particular drivers may be limited to traveling at less than 90% of the speed limit during daylight hours and at less than 80% of such speeds at night.

It is a further object of this invention to detect the presence of and to interpret various traffic control lights and signs. These may include traffic lights, stop signs and speed limit signs so that the information can be used by the VACS to set limits on vehicle operation. U.S. Pat. Nos. 6,449,384; 6,472,977; 6,560,529 and 7,068,844, the contents of which are incorporated herein by reference in their entirety, describe methods and apparatus that may be used to obtain speed limit and traffic control information.

It is a further object of this invention to determine the traffic control data, such as speed limit, at the location where the vehicle is traveling by use of a navigation system to establish vehicle location and a speed limit database that may be stored onboard the vehicle or received via a transmission link from an external source. U.S. Pat. No. 6,845,317, the contents of which are incorporated herein by reference in their entirety, describes a navigation system with a speed limit data source. Speed limit or traffic control information may also be received from specially designed traffic signs or control equipment that transmit the local speed limit or traffic control data in a manner that may be detected by the VACS system. U.S. Pat. No. 6,629,515, the contents of which are incorporated herein by reference in their entirety, describes a traffic signal that transmits the state of the signal. Alternatively, the system may utilize databases stored at a remote location to obtain local speed limits and other traffic control information.

If the VACS detects that the vehicle operator is impaired, the system may automatically curtail vehicle operation by reducing, for example in the case where the vehicle is a car or truck, the vehicle's maximum speed or by stopping the vehicle altogether. Alternatively, the driver may be ordered to leave the road to proceed to a specific location such as a police station.

It is a further object of this invention, when the VACS determines that there is an immediate danger of accident because of the impairment of the operator, it may automatically override some or all actions of the operator and control the operation of the vehicle so as to remove the vehicle from traffic or to stop the vehicle altogether. U.S. Pat. No. 6,517,172, the contents of which are incorporated herein by reference in their entirety, describes an automatic braking system.

Pedal control systems and sensors are described in U.S. Pat. Nos. 5,768,946, and 6,220,222, the contents of which are incorporated herein by reference in their entirety. U.S. Pat. No. 6,860,361, the contents of which are incorporated herein by reference in their entirety, describes an electric power steering control system. Systems for detecting the proximity of obstructions and for the automatic control of vehicles on the road are described in U.S. Pat. Nos. 6,400,308; 6,894,608; 6,906,639; 7,426,437; the contents of which are incorporated herein by reference in their entirety.

It is a further object of the present invention to notify the driver of the vehicle or others that the vehicle is being driven in an unsafe manner. Such other persons may include operators of other vehicles that may be put at risk and pedestrians who are in close proximity to the vehicle and may be exposed to danger. Such warnings may include the automatic operation of the horn or the emergency flashers. Information may also be transmitted automatically to others who are in remote locations such as the owner of the vehicle, police or insurance company representatives.

It is yet another object of this invention that a VACS may be incorporated in a vehicle during manufacture or added in the after market. It may be activated voluntarily by the owner of the vehicle for self-monitoring, by contract or agreement, for example, to obtain reduced insurance rates or in response to an order from a court or an administrative, regulatory or other authority.

### BRIEF DESCRIPTION OF FIGURES

FIG. 1 shows a schematic of an embodiment of a vehicle access control system (VACS) configured according to an embodiment of the invention.

FIG. 2 is a flowchart that shows a vehicle startup procedure using a VACS configured according to another embodiment of the present invention.

FIG. 3 is a flowchart that shows the post-startup procedure using a VACS configured according to another embodiment of the present invention.

FIG. 4 is a flowchart that shows another startup procedure using a VACS configured according to yet another embodiment of the invention.

FIG. 5 is a schematic that shows a car or truck steering wheel comprising touch sensitive detectors according to still another embodiment of the invention.

FIG. 6 is a schematic that shows an example of a dashboard and steering wheel of a car or truck configured according to a yet further embodiment of the invention.

FIG. 7 shows a schematic of an automobile with a dashboard camera and sensors to detect the position of the brake pedal, the accelerator pedal and the steering wheel configured according to another embodiment of the invention.

FIG. 8 shows a schematic of a steering wheel of a car or truck with touch sensitive detectors being touched by the operator, configured according to still another embodiment of the invention.

FIG. 9 shows a schematic of a portable alertness, acuity or reflex response (AARR) tester configured according to an aspect of the invention.

FIG. 10 shows a schematic of the portable AARR tester of FIG. 9 coupled to a docking station on a steering wheel of a car or truck.

FIG. 11 shows a schematic of another AARR tester with an integrated camera and LCD display configured according to an embodiment of the invention.

FIG. 12 shows the schematic of a pilot testing station comprising an AARR system configured according to a still further embodiment of the invention.

FIG. 13 shows a schematic of a communication link between a VACS and an ankle bracelet configured according to still another embodiment of the invention.

### DETAILED DESCRIPTION

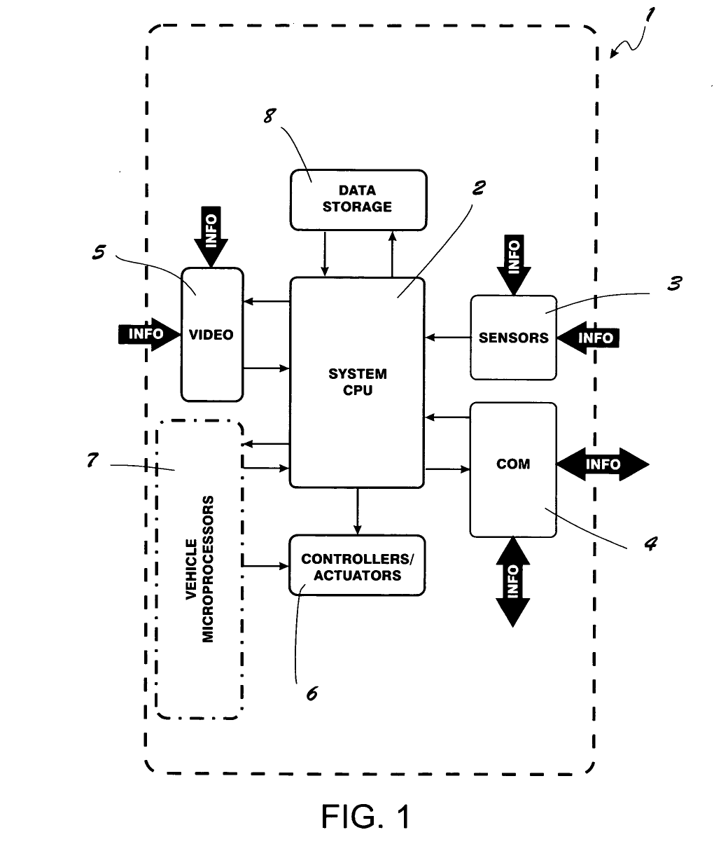

FIG. 1 shows a schematic of an embodiment of a vehicle access control system (VACS) configured according to the invention, comprising a microprocessor that monitors and regulates vehicle operation based on the identity of the operator and/or according to tests that determine the operator's AARR. The AARR is a measure of an operator's ability to safely operate the vehicle based at least partly on data collected during tests administered by the VACS prior to or after startup of the vehicle. Performance during a test may be compared to operator's previously obtained performance or baseline data that may be stored on-board or at a remote data storage location.

It shows a vehicle envelope 1 which comprises the VACS system central processing unit (SCPU) 2 configured to collect information about the vehicle, its surroundings and the operator and to control certain aspects of vehicle operation. The SCPU interfaces with sensors 3 that obtain information from both within and outside the vehicle. Sensors may detect, for example, the position of the brake and accelerator pedals, the current in the horn circuit, and the position of the steering wheel. Sensors may also be used to detect, for example, whether a particular seat is occupied, the speed at which the vehicle is traveling, if it is braking, and if the vehicle is swerving. Sensors may also detect, for example, ambient data such as weather conditions as well as the presence of other vehicles, pedestrians and obstructions. Sensors may also include, for example, transducers capable of collecting information about a vehicle operator or would-be operator such as, for example, fingerprint readers.

The SCPU shown in FIG. 1 is also configured to communicate, by using a communications link 4, with individuals within the vehicle including the operator or would-be operator or with individuals outside the vehicle or at remote locations. The communications link may also be used to collect information from transmitters, which may be located, for example, in an ankle bracelet, that provide information such as, for example, about the identity and blood alcohol level of a vehicle operator. A communications link may also be used to allow the operator to communicate, for example, with a remotely located technician who may participate in the determination of the operator identity and AARR.

The system in FIG. 1 also may comprise a video link 5 capable of obtaining video information from within and outside the vehicle. Video cameras may be used, for example, in conjunction with facial recognition software to identify the person sitting in the driver's seat. Video cameras may also be used, for example, to identify and interpret traffic signals and signs such as speed limit signs and stop signs or to locate other vehicles, pedestrians or obstructions.

The SCPU also may use controllers/actuators 6 to control various vehicle functions, such as speed, and to activate devices such as, for example, the horn, the emergency flashers, headlights, and taillights. It may be used to control fuel and air supply to the engine, the ignition system, and available electrical power. The SCPU may also interface with one or more vehicle microprocessors 7 to collect sensor data and effect vehicle operation.

Data storage 8 may be incorporated within the VACS to store data such as, for example, personal profile data about individuals authorized to operate the vehicle or baseline or driver data for comparison during AARR testing. Profiles may include information such as whether an individual has a valid license, a learner's permit or any restriction on where and when such an individual may operate a vehicle. Such a list may be modified, for example, if an individual's license is suspended for drunk driving. Information may also include, for example, operator restriction imposed by parents or guardians to, for example, restrict their childrens' access to a particular vehicle. Included in the profile may also be an indication of who may add an additional driver to the authorized list and any necessary passwords.

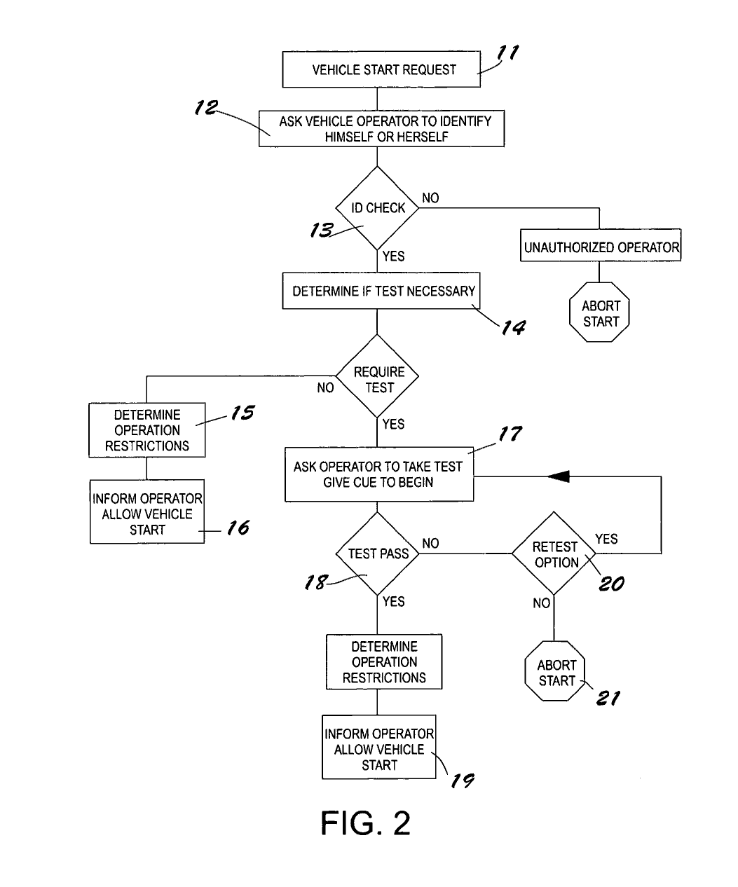

FIG. 2 is a flowchart that shows an example of a vehicle startup procedure using a VACS configured according to another embodiment of the present invention. A request to start a vehicle, such as a car, at block 11 may be generated by turning an ignition key, pressing one or more buttons in a keyless arrangement, and by using voice commands or a fingerprint reader. The VACS intercepts the request and initiates an operator identification at block 12. Preferably positive identification will be obtained by, for example, using a fingerprint scanner, facial recognition or voice recognition. Alternatively, identity data may be obtained, for example, by entering a password code with a key pad, verbally by saying one's name or using a magnetic ID card.

The system then confirms the identity of the operator in block 13 against a list of individuals, in its database, who are authorized to operate the vehicle at a given time and location. Such a database may be stored in data storage 8. If there is a match, the startup procedure is allowed to continue. Otherwise the would-be operator is informed that he or she is not authorized to operate the vehicle and startup is aborted. Based on the operator profile, the VACS determines if the operator needs to be tested in block 14. If not, the VACS checks the database to determine if the operator's profile calls for operational restrictions in block 15 and allows startup to proceed in block 16 with these restrictions. However, depending on the information in the database, it may be determined that testing is necessary. The startup procedure may also be configured such that only certain individuals need to be tested and all others are allowed to start and operate the vehicle without testing. The VACS may also be configured so that if the same driver attempts to start the vehicle after a short stop of, for example, 5 minutes or less, no AARR tests are performed.

If testing is required, the would-be operator is instructed to begin the test in block 17. Such instructions may be, for example, communicated by one or more various means such as visually, acoustically or verbally. The would-be operator may be required to take certain actions such as, for example, touching certain touch sensitive switches or surfaces or pressing certain pedals or buttons in a certain sequence. Alternatively or additionally, the test subject may be asked to respond verbally to questions or requests. The time to attempt and/or successfully complete one or more tasks as specified by the VACS is determined. The measured duration is then, preferably, compared in block 18 to the time taken, by the same individual, to perform the same or equivalent tasks previously under similar or controlled conditions or during previously administered tests. Data under controlled conditions may be previously collected, for example, at a state motor vehicle department or police station and stored on the VACS data storage. Alternatively, the time measured during the test may be compared to threshold data that is based on expected performance by the general population or a certain class of individuals such as persons of a certain age. If the measured time is below an acceptable threshold, the would-be operator is informed that he or she has passed the test and vehicle startup is allowed to proceed in block 19. If the test subject fails to perform the tasks sufficiently quickly or accurately, the system will indicate that the vehicle may not be started and may offer a retest option after a predetermined delay in block 20. This may be based on, for example, the operator profile and the number of previously failed tests. If the retest option is not available or is rejected by the would-be operator, the startup is aborted in block 21.

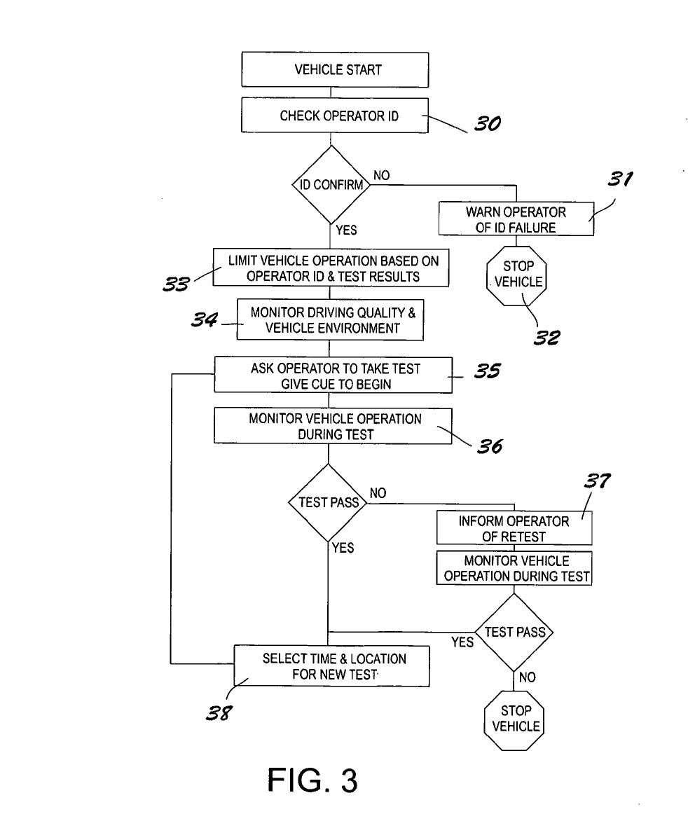

FIG. 3 is a flowchart that shows an example of a post-startup procedure configured according to a further embodiment of the present invention. During operation, the identity of the operator may be rechecked after startup at block 30. If the identification of the operator cannot be confirmed, if the operator is not the person who was tested during the pre-startup process or if the operator is identified as a person who has not passed a required startup test, the operator is warned in block 31 and the vehicle is stopped in block 32 or alternatively its operation is restricted (not shown). For example, the maximum speed of the vehicle may be limited and the operator may be precluded from entering a highway.

If the operator ID is confirmed, the vehicle operation is allowed to continue in block 33 based on restrictions in the operator's profile and previous test results.

The system will also monitor the operation in block 34 of the vehicle to determine if the operator may be impaired. For example, the system may monitor whether the operator is reacting properly to road conditions, for example, by applying the brakes at the proper time and to the correct degree to decelerate the vehicle in a timely fashion when necessary, by not swerving unnecessarily and by abiding with traffic regulations.

During vehicle operation, the VACS may also inform the operator that he or she will be retested in block 35. Retest may occur at a random time or because the VACS has detected unacceptable driver behavior. The system will then indicate tasks that need to be performed and give a cue to begin. The system may also monitor vehicle operation during the test to determine if vehicle operation is degrading during the test in block 36. If vehicle operation degrades or a dangerous situation arises, the test may be discontinued. If the operator fails the test or if it has to be discontinued, the operator may be given one or more opportunities at block 37 to retest.

If the operator passes the test, operation may continue. Tests may be repeated in block 38 periodically. ID match and/or tests may be repeated (not shown) when there is a possibility that a new operator may be in control of the vehicle. For example, if the vehicle is stopped and the driver's door is opened or when a seat sensor indicates that the driver has gotten off the driver's seat, the system may repeat with at least an ID check.

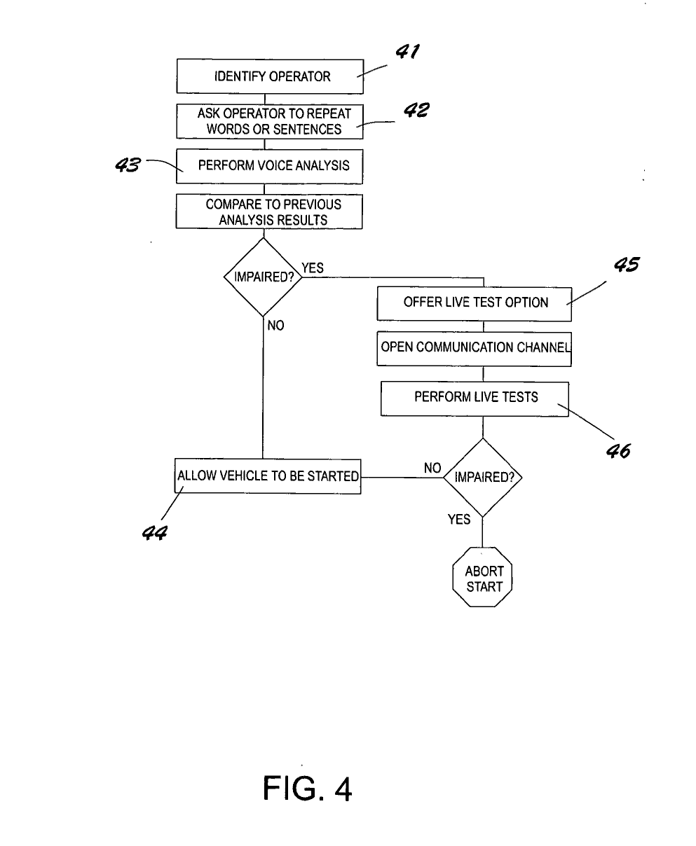

FIG. 4 is a flowchart that shows a startup procedure using a system configured according to yet another embodiment of the invention. In this procedure, the would-be operator is identified in block 41. Subsequently, he or she is asked to repeat a series of words or sentences in block 42. Based on voice analysis of the response or preferably by comparison of the real time voice samples to prerecorded voice samples of the particular individual, it is determined whether the test subject is impaired in block 43. If the would-be operator is not impaired, the startup is allowed to continue 44.

If it is determined that the would-be operator is impaired, he or she is given a live test option in block 45. During the live test, the would-be operator may be asked to repeat certain words or sentences. A remotely located technician may analyze at block 46 the voice records of the automated or the live test to determine if the test taker is impaired. Preferably the technician will also have access to previously obtained baseline voice samples to compare to. If the technician determines that the operator is not impaired, the startup procedure is allowed to proceed. If it is determined that the operator is impaired, the startup is aborted.

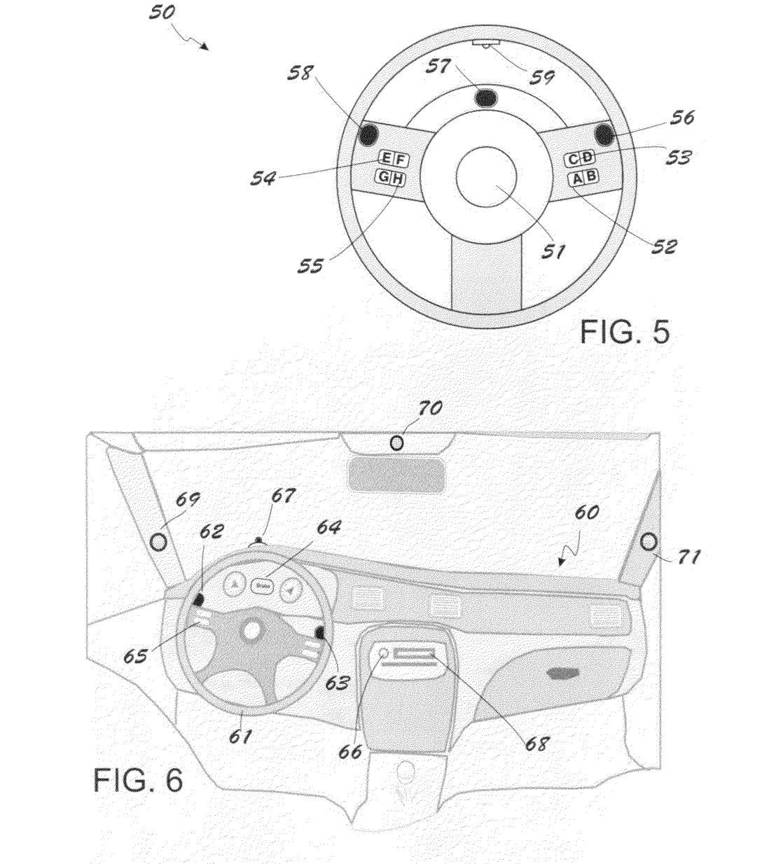

FIG. 5 is a schematic that shows a car or truck steering wheel configured according to still another embodiment of the invention. Wheel 50 comprises touch sensitive switches that may be used to test an operator's AARR prior to or after startup. The horn 51 and buttons 52-55 (labeled A-F) may have other conventional uses such as, for example, controlling the radio and cruise control.

These buttons may also be used to test the AARR of the vehicle operator by determining the length of time it takes the operator to push one or more of these buttons in a particular sequence after being instructed to do so. For example, the operator may be instructed to press buttons in the sequence CDG as quickly as he/she is able to.

The test may be conducted while the vehicle is in motion. The time for completing the task is measured and used to determine the operator's AARR. Preferably this time is compared to the time taken by the operator to complete the same or similar tasks under controlled conditions or during previous tests.

Alternatively, special purpose dedicated detectors 56-59 may be used to measure the operator response. In FIG. 5, detector 59 is a conventional switch that may be pressed to close a circuit or generate a signal that may be detected by the SCPU.

One or more detectors 56-58 may be fingerprint scanners that can sense when the operator places his or her finger on it, as well as read that person's fingerprint. The operator may be tested based on the time taken to complete a given task as well as how accurately the task is completed. By including the fingerprint scanners in the test sequence, the VACS system can determine the identity of the person taking the test. For example, the operator may be instructed to keep his left thumb on sensor 58 and then place his or her right index finger on detectors 52, 55, and 57 in a specified order and then rest his or her right thumb on sensor 56.

As an added test, especially if the vehicle is in motion, the system may also monitor any movement of the steering wheel to determine if any unnecessary movements are made by the operator during the test. Such unnecessary movements may also be used as an indicator of impaired operation.

FIG. 6 is a schematic that shows the dashboard 60 and steering wheel 61 of a car or truck configured according to a yet further embodiment of this invention. Detectors 62 and 63 are dedicated detectors that are touch sensitive. Preferably, they are also fingerprint scanners. Display 64 may be used to convey visual commands to the driver to perform certain tasks such as to place a finger on detectors 62 or 63 or to press one or more buttons such as 65 or 66.

Video camera 67 may be used to confirm the identity of the person sitting in the driver's seat. The radio speaker 68 may be used to give the driver voice commands. One or more microphones 69-71 may be used by the VACS to obtain verbal responses from the driver.

The system may use voice analysis of the voice record obtained by these microphones to identify the speaker. By using multiple microphones, the system may use various methods, such as, for example, by measuring time of flight of sound waves or relative sound energy at different locations, to assure that the responses being received are being spoken by the occupant of the driver's seat.

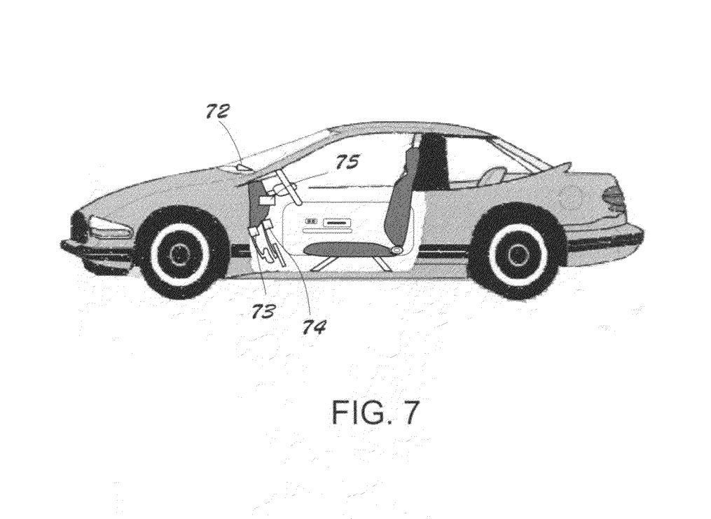

FIG. 7 shows a schematic of an automobile configured according to an embodiment of the invention with camera 72 for capturing images of traffic signs and signals. These images may be interpreted to determine posted speeds and if the operator is properly following the rules of the road. Alternatively, this information may be used to establish a speed limit that restricts the operator of the vehicle to a fraction of the posted speed limit.

Sensors 73, 74 and 75 may be used to detect the motion of the various pedals and the steering wheel. 73 and 74 may be, for example, proximity sensors while 75 may be a shaft encoder.

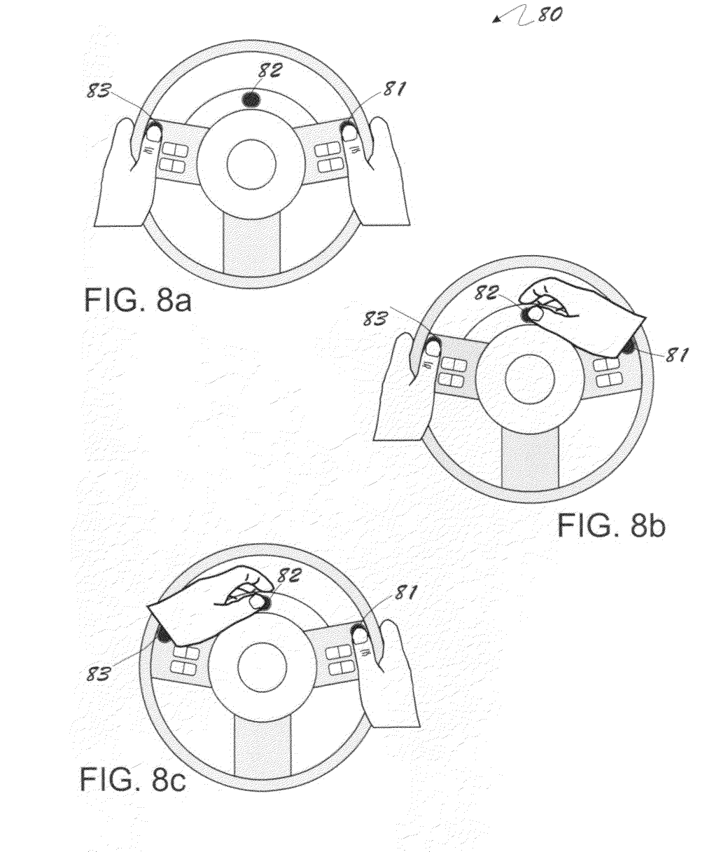

FIG. 8 shows a schematic of a steering wheel 80 configured according to still another embodiment of this invention. The steering wheel comprises three touch sensitive detectors. Preferably, at least one of the detectors is also a fingerprint scanner. At least one fingerprint scanner is preferably located so that it is convenient for the operator to substantially continuously maintain his or her thumb on the detector during the operation of the vehicle. Therefore, the operator may be asked by the VACS to place his thumb on a fingerprint scanner during the operation of the vehicle so that the operator identity may be determined at any time.

During an AARR test, the operator may first be asked to maintain his thumbs on detectors 81 and 83. The operator may then be given verbal, audible or visual cues to touch one or more of the other touch sensitive surfaces as quickly as possible. The time to perform the task is measured by the VACS. FIG. 8b shows the operator placing his right thumb on detector 82 while maintaining his left thumb on 83. FIG. 8b shows that the operator has returned his right thumb to detector 81 and placed his left thumb to detector 82. The time to perform each of these tasks is measured. The ability of the operator to maintain the stability of the steering wheel during the tests may also be monitored and used in the evaluation of the operator.

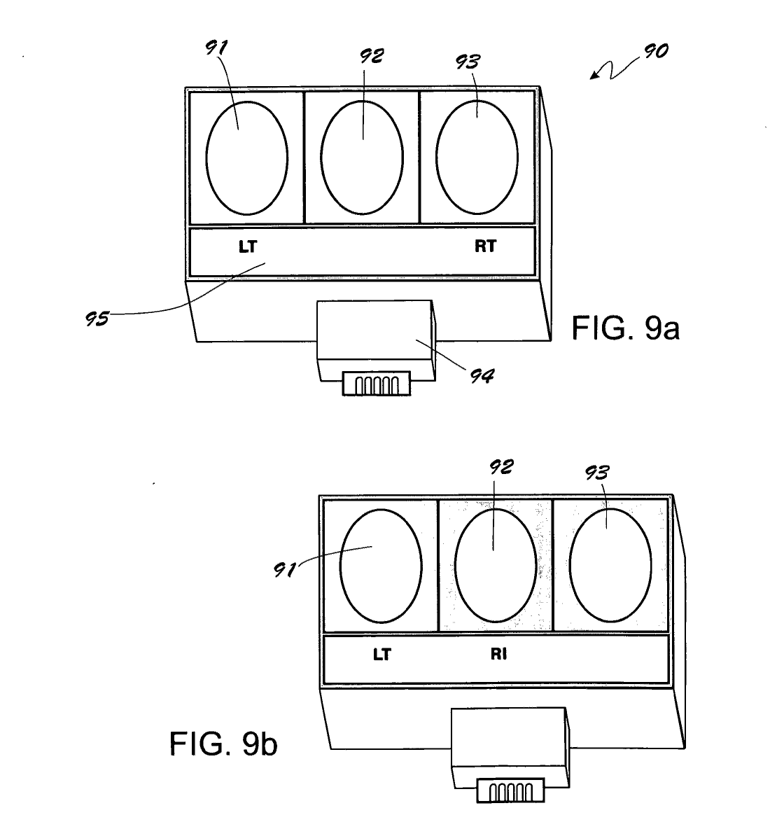

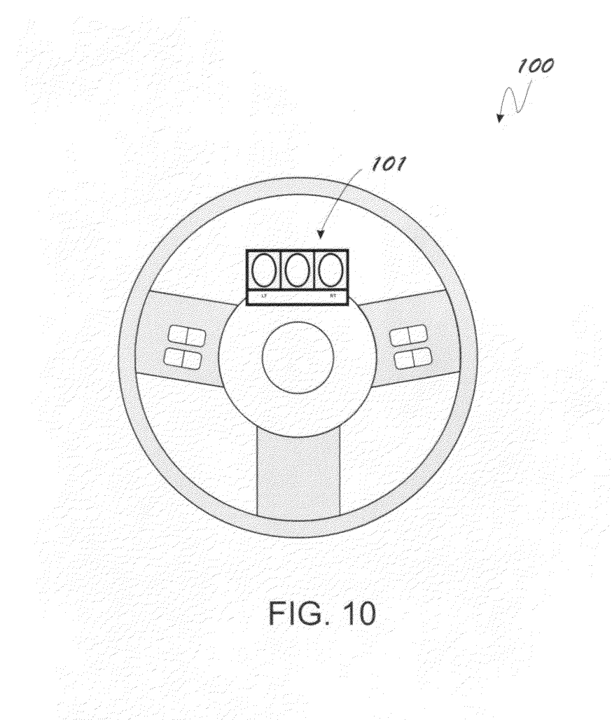

FIG. 9 shows a schematic of a portable AARR tester 90 with multiple touch sensitive detectors 91-93. Preferably, one or more of these detectors is also a fingerprint scanner. A display 94 is used to give visual cues or commands to a test taker. In FIG. 9a, the test taker is instructed to place his left thumb (LT) on detector 91 and right thumb (RT) on detector 93. In FIG. 9b, the test subject is instructed to keep his left thumb on detector 91 and to place his right index (RI) finger on detector 92.

The portable tester may be used to perform a pre-startup AARR test prior to entering the vehicle. Data storage on the portable tester will retain test results. The results of the test may be transferred to the VACS by means of connecter 95 or other communication link in lieu of taking the test while seated in the vehicle before startup.

FIG. 10 shows a steering wheel 100 configured to accept a portable tester 101. The tester may also be used after it is attached to the steering wheel.

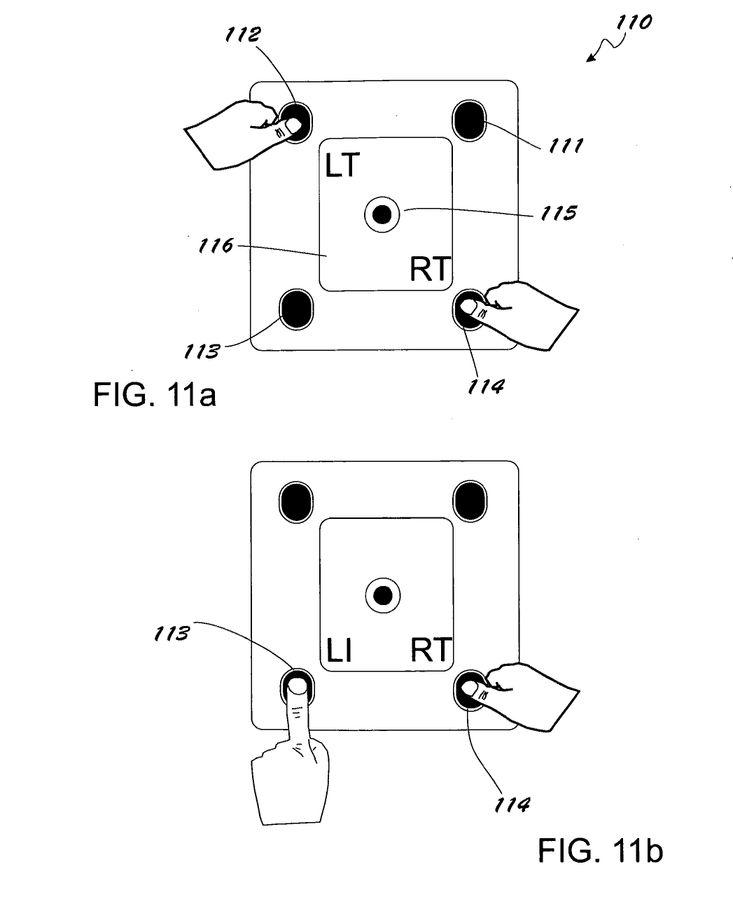

FIG. 11 shows a schematic of an AARR tester 110 with four touch sensitive detectors 111-114, with an integrated camera 115 and LCD display 116. Preferably one or more of the detectors are fingerprint scanners. FIG. 11a shows that the test subject is placing his right thumb (RT) on 114 and left thumb (LT) on 112. FIG. 11 shows that the test subject is placing his left index (LI) finger on detector 113 and right thumb (RT) on 114. Labels such as LT, RT, and LI are displayed on the display 116 to instruct the test subject which finger to place on which detector at any given time.

AARR tester 110 may be incorporated in the vehicle or be configured to function independently and communicate remotely with the VACS using a communication link. It may also be used in a test facility, such as, for example, at an airport where pilots or other air crew may be tested prior to operating aircraft. A telephone booth sized enclosure may be configured with tester 110 where a test taker may receive verbal instructions in privacy and without disturbing others.

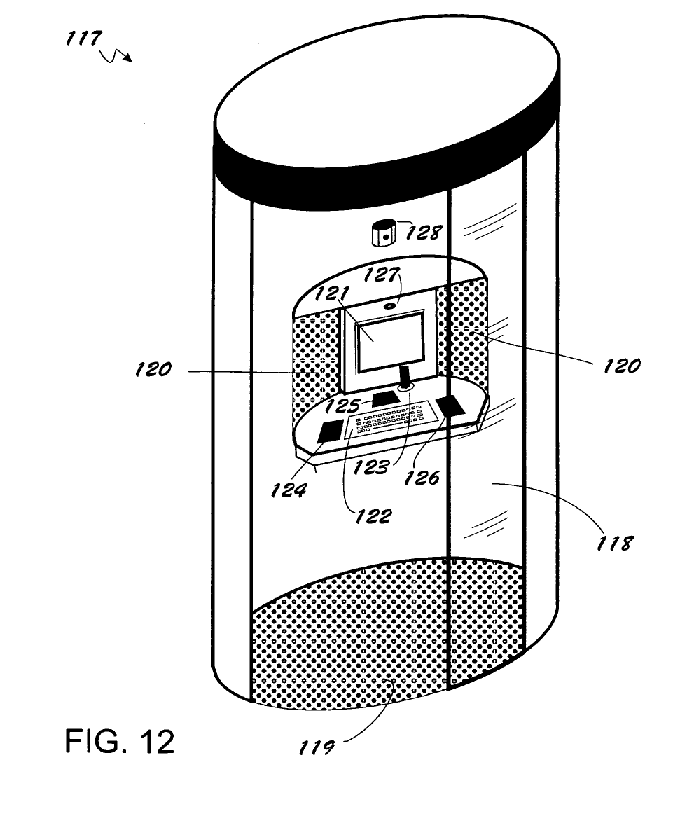

FIG. 12 is a schematic of an AARR test booth that may be placed, for example, in an airport terminal. The test subject stands in the booth and closes door 118 to ensure privacy and that he or she does not receive any assistance. The door is configured with sensors so that the VACS system can determine when it is closed. Sensors may also be used to ensure that there is only one person in the booth during the test. For example, the floor 119 may be configured to measure the test subject's weight. The subject's weight may then be compared with the test subject's profile in the database once the test taker is identified.

In the embodiment in FIG. 12, during the test, the test taker receives verbal or written instruction, for example, by means of speakers 120 or monitor 121. Cues and instructions may also be given by other means, such as, for example, chimes or LEDs. The test subject may also be instructed to use keyboard 122, joystick 123, or touch sensitive detectors 124, 125, and 126. These touch sensitive scanners may be biometric sensors, such as palm or fingerprint readers, that are used to identify the person touching them. Microphone 127 may be used to receive verbal responses from the test subject. Video camera 128 may be used to capture an image of the test subject so that his or her identity may be confirmed by using facial recognition. Based on test results obtained and evaluated by the VACS, the test subject may be cleared to board the aircraft as a member of the flight crew for a certain period of time after the test. The VACS may then generate appropriate credentials and notify appropriate authorities to permit the tested individuals to board a particular flight. The test booth may be configured to include other testing devices such as, for example, a breathalyzer (not shown). The VACS SCPU may be located at the booth or at a remote location and connected to the booth by means of a communication link.

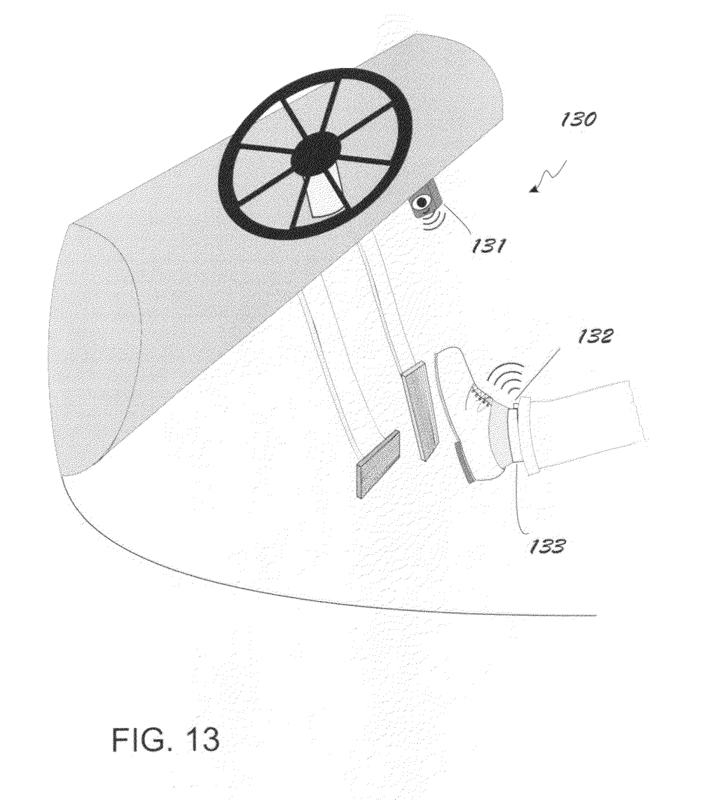

FIG. 13 shows the foot well area 130 of a car or truck configured according to a further embodiment of the invention.

A transmitter or transmitter/receiver 131 communicates with a transmitter or transmitter/receiver 132 attached to the ankle bracelet 133 of a driver. Preferably, the transmitter/receiver 131 is directional so that communication is established only with an ankle bracelet located in the driver's wheel well.

Information may be obtained about the identity and blood alcohol level of the driver. The data profile of certain operators may indicate that continuous communication with the ankle bracelet is a requirement for vehicle operation by a particular operator.

The invention has been described in terms of its functional principles and several illustrative embodiments. Many variants of these embodiments will be obvious to those of skill in the art based on these descriptions. Therefore, it should be understood that the ensuing claims are intended to cover all changes and modifications of the illustrative embodiments that fall within the literal scope of the claims and all equivalents thereof.

What we claim is:

1. A system for controlling access to a vehicle comprising
at least one touch sensitive fingerprint scanner
a communication device for instructing a person in said vehicle
a device for determining when at least one touch sensitive device is touched
